(19) United States
(12) Patent Application Publication
(10) Pub. No.: US 2024/0308012 A1
(43) Pub. Date: Sep. 19, 2024

(54) BIFURCATED DUST-COLLECTING ADAPTOR FOR SPRAY GUN

(71) Applicant: Chin-Nan CHEN, Keelung City (TW)

(72) Inventor: Chin-Nan CHEN, Keelung City (TW)

(21) Appl. No.: 18/304,706

(22) Filed: Apr. 21, 2023

(30) Foreign Application Priority Data
Mar. 14, 2023 (TW) 11220222

(51) Int. Cl. B23Q 11/00; A47L 7/00; B05B 7/02

(52) U.S. Cl. CPC B23Q 11/0071; A47L 7/0095; B05B 7/02

(57) ABSTRACT

A bifurcated dust-collecting adaptor for spray gun includes a spray-gun connecting pipe, a vacuum adaptor and a dust-collecting hood. The spray-gun connecting pipe includes a main pipe body and an oblique extension pipe. The main pipe body extends in a first direction from a first connecting portion to a second connecting portion. The first connecting portion is assembled to a gun pipe of the fluid spray gun. The oblique extension pipe protrudes from the adaptor body in a second direction oblique to the first direction. The vacuum adaptor includes an adaptor body, a first connecting portion and a second connecting portion. The first connecting portion protrudes from the adaptor body for being rotationally assembled to the oblique extension pipe. The second connecting portion protrudes from the adaptor body for being assembled to a dust-collecting hose of the dust-collecting device. The dust-collecting hood is rotationally assembled to the second connecting portion.

This application claims the benefit of Taiwan Patent Application Serial No. 112202222, filed Mar. 14, 2023, the subject matter of which is incorporated herein by reference.

### BACKGROUND OF THE INVENTION

### (1) Field of the Invention

The invention relates to a bifurcated dust-collecting adaptor for spray gun, and more particularly to the bifurcated dust-collecting adaptor for spray gun that can integrates a fluid spray gun and a dust collector.

### (2) Description of the Prior Art

In daily life, while in cleaning home environment, vacuum devices are usually utilized to generate negative pressures to absorb the dust or debris on the floor or desktop. However, when using the vacuum devices to absorb these dirt, there are always some dirt stubbornly attached to a surface. In particular, these dirt are usually extremely small, and thus likely to be ignored. As time goes, these stubborn dust will become even more difficult to remove.

Generally speaking, a common way to remove dirt is to scrape off the dirt through direct contact, but such a move would be time-consuming and labor-intensive. Thus, a bifurcated dust-collecting adaptor for spray gun is introduced to combine the spray gun and a vacuum device. With this design, the fluid sprayed by the spray gun would be still led to impact the dirt and further to loosen and fall off the dirt, and simultaneously the vacuum device is applied to suck the dirt away, so that labor-saving and efficiency can be both achieved.

As described above, although the existing bifurcated dust-collecting adaptor for spray gun can integrate the spray gun and the vacuum device, yet a three-way pipe to connect both the spray gun and the vacuum device so as to share the same inlet and outlet does cause problems in assembling. Practically, with the three-way pipe common to the vacuum device and the spray gun, the vacuum device can be only assembled at a fixed angle. As a result, such a fixed angle would make the user easily restrained by the vacuum device when using the spray gun, from which operational fluency and convenience would be affected.

### SUMMARY OF THE INVENTION

In view that, though the conventional spray gun and vacuum device can be integrated through a bifurcated dust-collecting adaptor for spray gun, yet the spray gun and the vacuum device are directly fixed to the dust-collecting kit by fixed angles. Thus, while in operating the spray gun, such a fixed-angle design would be easily effected in convenience. Accordingly, it is an object of the present invention to provide a bifurcated dust-collecting adaptor for spray gun that can free the angling between the spray gun and the vacuum device.

In this invention, a bifurcated dust-collecting adaptor for spray gun, assembled to a fluid spray gun and a dust-collecting device, includes a spray-gun connecting pipe, a vacuum adaptor and a dust-collecting hood.

The spray-gun connecting pipe includes a main pipe body and an oblique extension pipe. The main pipe body is extended in a first direction thereof from a first connecting portion to a second connecting portion. The first connecting portion is to be assembled to a gun pipe of the fluid spray gun, and the second connecting portion is connected spatially with the first connecting portion. The oblique extension pipe is protruded from the main pipe body in a second direction oblique to the first direction.

The vacuum adaptor includes an adaptor body, a first connecting portion and a second connecting portion. The first connecting portion, protruding from the adaptor body in a third direction reverse to the second direction, is configured to be rotationally assembled to the oblique extension pipe. The second connecting portion, protruding from the adaptor body in a fourth direction oblique to the third direction, is configured to be assembled to a dust-collecting hose of the dust-collecting device.

The dust-collecting hood is rotationally assembled to the second connecting portion.

In one embodiment of this invention, the second connecting portion has a first outer pipe wall, and the dust-collecting hood has a first inner pipe wall to match the first outer pipe wall. Preferably, the first outer pipe wall and the first inner pipe wall are individually tapered in the first direction.

In addition, the dust-collecting hood further includes a hood pipe and a horn-shape hood. The hood pipe, extending in the first direction, has a first inner pipe wall. The horn-shape hood, connected spatially with the hood pipe, is gradually enlarged in the first direction.

In one embodiment of this invention, the oblique extension pipe has a second inner pipe wall, and the first connecting portion has a second outer pipe wall to match the second inner pipe wall. Preferably, the second inner pipe wall and the second outer pipe wall are individually tapered in the third direction.

In one embodiment of this invention, the main pipe body has an in-pipe space for allowing the gun pipe to penetrate therethrough, and the first connecting portion has a locking hole connected spatially with the in-pipe space, such that, when the gun pipe penetrates through the in-pipe space, a fastener locks the gun pipe in the in-pipe space via the locking hole.

As stated above, since the vacuum adaptor of the bifurcated dust-collecting adaptor for spray gun is rotationally connected with the spray-gun connecting pipe, and thus the flexibility and convenience of the fluid spray gun can be improved through the rotational engagement between the vacuum adaptor and the spray-gun connecting pipe, even that the dust-collecting device is fixed to the vacuum adaptor

All these objects are achieved by the bifurcated dust-collecting adaptor for spray gun described below.

### BRIEF DESCRIPTION OF THE DRAWINGS

The present invention will now be specified with reference to its preferred embodiment illustrated in the drawings, in which:

FIG. 1 is a schematic exploded view of a first embodiment of the bifurcated dust-collecting adaptor for spray gun in accordance with the present invention;

FIG. 2 is a schematic cross-sectional view of FIG. 1;

FIG. 3 is a schematic cross-sectional view of a second embodiment of the bifurcated dust-collecting adaptor for spray gun in accordance with the present invention;

FIG. 4 is a schematic view of the first embodiment of the bifurcated dust-collecting adaptor, a fluid spray gun, a cyclone nozzle and a dust-collecting device in a separate state in accordance with the present invention;

FIG. 5 is a schematic perspective view of FIG. 4 in an assembly state;

FIG. 6 is a schematic cross-sectional view of FIG. 5 along line A-A;

FIG. 7 is a schematic view of the first embodiment of the bifurcated dust-collecting adaptor, the fluid spray gun, a gas-operated nozzle and the dust-collecting device in a separate state in accordance with the present invention;

FIG. 8 is a schematic view of the first embodiment of the bifurcated dust-collecting adaptor, a gas-fluid spray gun, a gas-operated nozzle and the dust-collecting device in a separate state in accordance with the present invention;

FIG. 9 is a schematic perspective view of FIG. 8 in an assembly state;

FIG. 10 is a schematic cross-sectional view of FIG. 9 along line B-B; and

FIG. 11 is a schematic view of the first embodiment of the bifurcated dust-collecting adaptor, a gas-fluid spray gun, a cyclone nozzle and the dust-collecting device in a separate state in accordance with the present invention.

### DESCRIPTION OF THE PREFERRED EMBODIMENT

The invention disclosed herein is directed to a bifurcated dust-collecting adaptor for spray gun. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

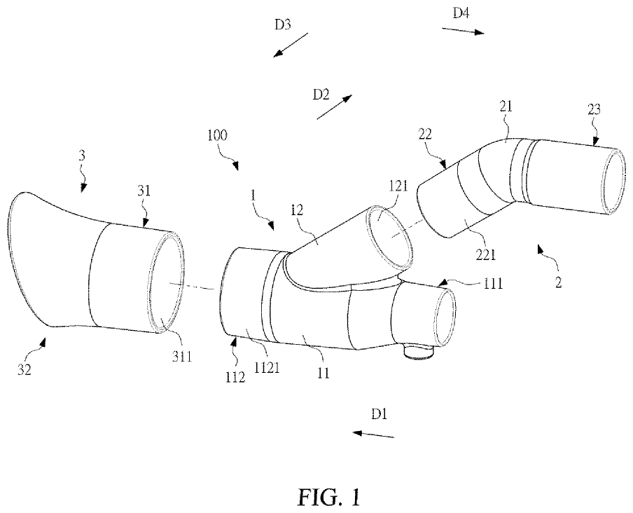

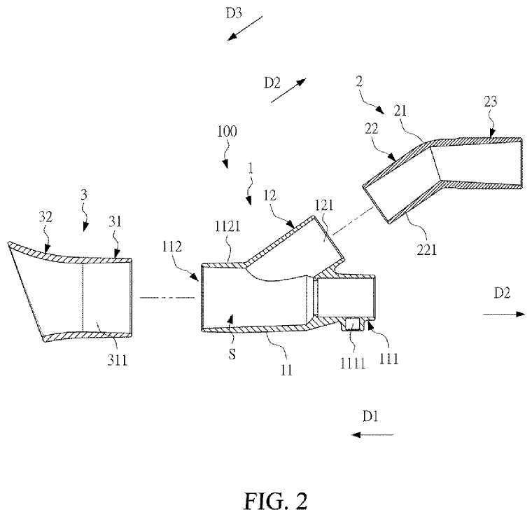

Please refer to FIG. 1 and FIG. 2; where FIG. 1 is a schematic exploded view of a first embodiment of the bifurcated dust-collecting adaptor for spray gun in accordance with the present invention, and FIG. 2 is a schematic cross-sectional view of FIG. 1.

As shown in FIG. 1 and FIG. 2, the bifurcated dust-collecting adaptor for spray gun 100 includes a spray-gun connecting pipe 1, a vacuum adaptor 2 and a dust-collecting hood 3.

The spray-gun connecting pipe 1 includes a main pipe body 11 and an oblique extension pipe 12. The main pipe body 11, extending from a first connecting portion 111 to a second connecting portion 112 in a first direction D1, defines thereinside an in-pipe space S connecting spatially the first connecting portion 111 and the second connecting portion 112. The first connecting portion 111 further has a locking hole 1111 connected spatially with the in-pipe space S. In addition, the second connecting portion 112 has a first outer pipe wall 1121.

The oblique extension pipe 12, extending in a bifurcated way from the main pipe body 11 in a second direction D2 oblique to the first direction D1, has a second inner pipe wall 121.

The vacuum adaptor 2 includes an adaptor body 21, a first connecting portion 22 and a second connecting portion 23. The first connecting portion 22, protruding from the main pipe body 11 in a third direction D3 reverse to the second direction D2, is configured to be rotationally assembled to the oblique extension pipe 12. In addition, the first connecting portion 22 further has a second outer pipe wall 221 to match the second inner pipe wall 121 so as for the first connecting portion 22 to engage the oblique extension pipe 12 in a close-fit manner.

The second connecting portion 23, protruding from the adaptor body 21 in a fourth direction D4 inclined to the third direction D3, is configured to be assembled to a dust-collecting hosed of the ust-collecting device.

As described above, since the close-fit engagement between the second outer pipe wall 221 and the second inner pipe wall 121 is achieved by the friction formed in between, thus, when the rotational moment of the first connecting portion 22 is greater than the friction, the first connecting portion 22 would rotate with respect to the oblique extension pipe 12. On the other hand, when the first connecting portion 22 rotates and stops at a specific angle with respect to the oblique extension pipe 12, the angle in between can be still held by the friction.

The dust-collecting hood 3 includes a hood pipe 31 and a horn-shape hood 32. The hood pipe 31, extending in the first direction D1, is configured to be rotationally assembled to the second connecting portion 112. The horn-shape hood 32, connected spatially with the hood pipe 31, is gradually enlarged in the first direction D1. The hood pipe 31 further has a first inner pipe wall 311 for matching the first outer pipe wall 1121 to have the hood pipe 31 to engage, by sleeving, the second connecting portion 112 in a close-fit manner.

As described above, since the close-fit contact of the first outer pipe wall 1121 and the first inner pipe wall 311 is achieved by the induced friction in between, thus, when the rotational moment upon the dust-collecting hood 3 is greater than a static friction, the hood pipe 31 would rotate with respect to the second connecting portion 112. On the other hand, when the hood pipe 31 rotates and stops after a specific angle is reached with respect to the second connecting portion 112, then the angling between the first outer pipe wall 1121 and the first inner pipe wall 311 can be relevantly adjusted per practical.

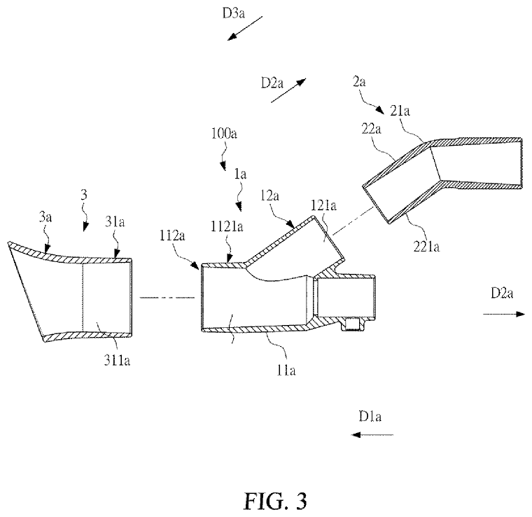

Referring to FIG. 3, a schematic cross-sectional view of a second embodiment of the bifurcated dust-collecting adaptor for spray gun in accordance with the present invention is shown. In FIG. 1 to FIG. 3, a bifurcated dust-collecting adaptor for spray gun 100a is similar to the aforesaid bifurcated dust-collecting adaptor for spray gun 100, but a major difference in between is that, in this embodiment, the bifurcated dust-collecting adaptor for spray gun 100a have a spray-gun connecting pipe 1a, a vacuum adaptor 2a and a dust-collecting hood 3a to replace the aforesaid spray-gun connecting pipe 1, vacuum adaptor 2 and dust-collecting hood 3.

As described above, the spray-gun connecting pipe 1a has a main pipe body 11a and an oblique extension pipe 12a. The main pipe body 11a is extended in a first direction D1a from a first connecting portion 111a to a second connecting portion 112a, and the second connecting portion 112a has a first outer pipe wall 1121a. In addition, an obvious difference between the first outer pipe wall 1121a and the aforesaid first outer pipe wall 1121 is that the first outer pipe wall 1121a is extended in a taper manner in the first direction D1a.

The oblique extension pipe 12a, protruding from the main pipe body 11a in a second direction D2a oblique to the first direction D1a, has a second inner pipe wall 121a. A difference between the second inner pipe wall 121a and the aforesaid second inner pipe wall 121 is that the second inner pipe wall 121a is extended in a taper manner in a third direction D3a reverse to the the second direction D2a.

On the other hand, since a first connecting portion 22a of the vacuum adaptor 2a is configured to match the oblique extension pipe 12a, and thus a second outer pipe wall 221a of the first connecting portion 22a is tapered in the third direction D3a to engage the second inner pipe wall 121a. With the second inner pipe wall 121a and the second outer pipe wall 221a to be designed in the taper manner in the third direction D3a, thus, when the first connecting portion 22a is plugged to engage the oblique extension pipe 12a, such a taper design in the third direction D3a at the second inner pipe wall 121a and the second outer pipe wall 221a would guide the first connecting portion 22a to engage the oblique extension pipe 12a much smoother, and the engagement between the first connecting portion 22a and the oblique extension pipe 12a can be further tightened by providing larger assembly forcing.

Similarly, since a hood pipe 31a of the dust-collecting hood 3a is configured to assemble the first connecting portion 111a, thus a first inner pipe wall 311a of the hood pipe 31a is also tapered in the first direction D1a to match the first outer pipe wall 1121a, such that the hood pipe 31a can sleeve the second connecting portion 112a in a close-fit manner. With this taper design in the first direction D1a at the first outer pipe wall 1121a and the first inner pipe wall 311a, then, when the hood pipe 31a sleeves the second connecting portion 112a, such a taper design in the first direction D1a at the first outer pipe wall 1121a and the first inner pipe wall 311a would guide the hood pipe 31a to engage the second connecting portion 112a much smoother, and the engagement between the hood pipe 31a and the second connecting portion 112a can be further tightened by providing larger assembly forcing.

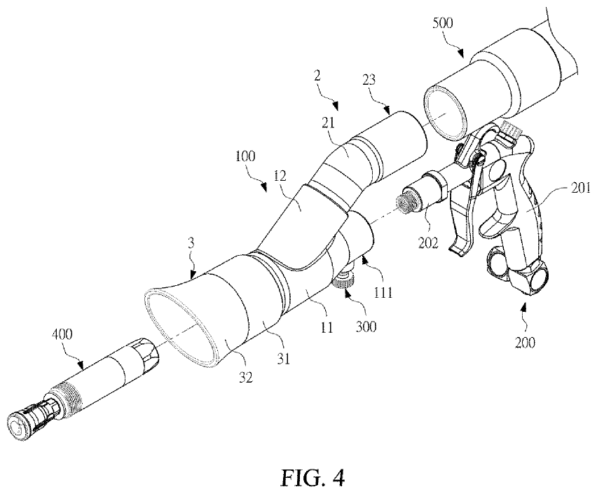

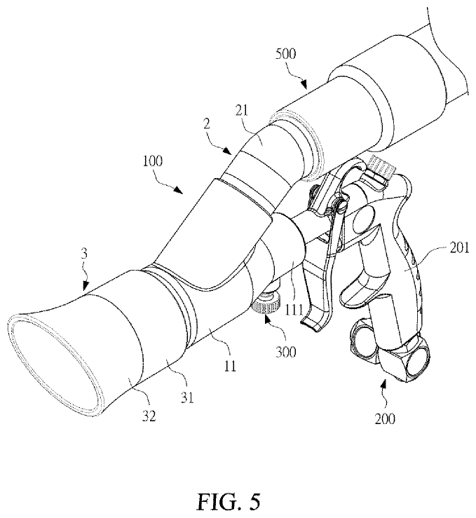

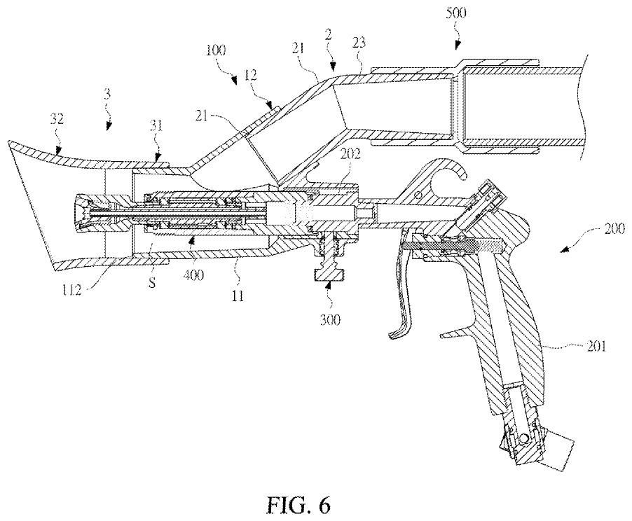

Refer now to FIG. 4 to FIG. 6; where FIG. 4 is a schematic view of the first embodiment of the bifurcated dust-collecting adaptor, a fluid spray gun, a cyclone nozzle and a dust-collecting device in a separate state in accordance with the present invention, FIG. 5 is a schematic perspective view of FIG. 4 in an assembly state, and FIG. 6 is a schematic cross-sectional view of FIG. 5 along line A-A. As shown from FIG. 1 to FIG. 6, the aforesaid first embodiment of the bifurcated dust-collecting adaptor for spray gun 100 is actual to pair a fluid spray gun 200, a cyclone nozzle 400 and a dust-collecting hose 500 of the dust-collecting device (not shown in the figure).

The fluid spray gun 200 includes a spray-gun grip 201 and a gun pipe 202. The spray-gun grip 201 is configured to connect a high-pressure air source (not shown in the figure), and the gun pipe 202 is used to connect the spray-gun grip 201. The first connecting portion 111 is to sleeve the gun pipe 202, and, after the gun pipe 202 enters the in-pipe space S via the first connecting portion 111, a fastener 300 can be sent into the locking hole 1111 to directly contact the gun pipe 202, such that the spray-gun connecting pipe 1 can be effectively engage the fluid spray gun 200.

On the other hand, cyclone nozzle 400 is locked to the gun pipe 202 in both the spray-gun connecting pipe 1 and the dust-collecting hood 30. Practically, after the cyclone nozzle 400 can be firstly assembled to the gun pipe 202, the cyclone nozzle 400 and the gun pipe 202a are then sent into the spray-gun connecting pipe 1 together.

In addition, the dust-collecting hose 500 protruded from the dust-collecting device is assembled to the second connecting portion 23, such that the dust-collecting hose 500 can be connected spatially with the spray-gun connecting pipe 1 and the dust-collecting hood 3 via the vacuum adaptor 2.

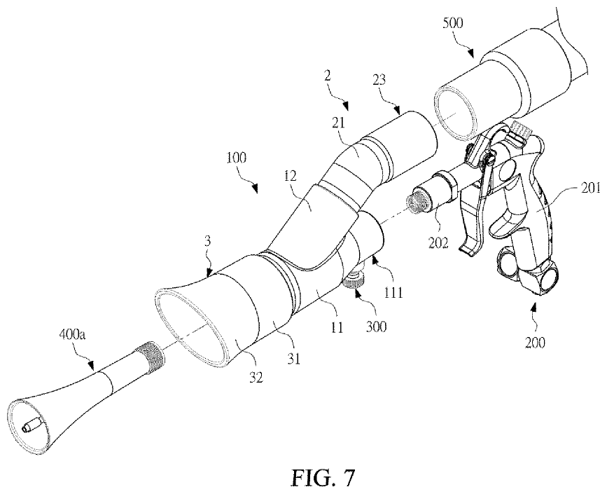

Referring to FIG. 7, a schematic view of the first embodiment of the bifurcated dust-collecting adaptor, the fluid spray gun, a gas-operated nozzle and the dust-collecting device in a separate state in accordance with the present invention is shown.

As shown in FIG. 1 to FIG. 7, except able to be assembled to the cyclone nozzle 400, the aforesaid first embodiment of the bifurcated dust-collecting adaptor for spray gun 100 can be also assembled to a gas-operated nozzle 400a. Assembling of the gas-operated nozzle 400a is the same as that of the aforesaid cyclone nozzle 400; i.e., being assembled to the gun pipe 202. However, due to a larger opening, the gas-operated nozzle 400a can be assembled to the gun pipe 202 in the spray-gun connecting pipe 1 via the dust-collecting hood 3.

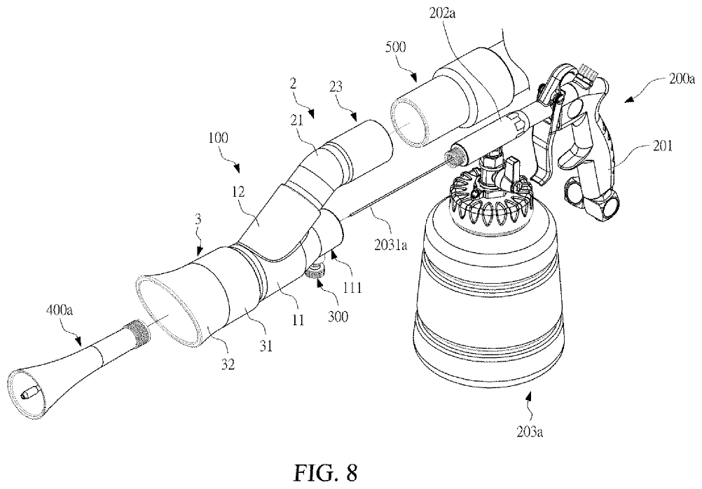

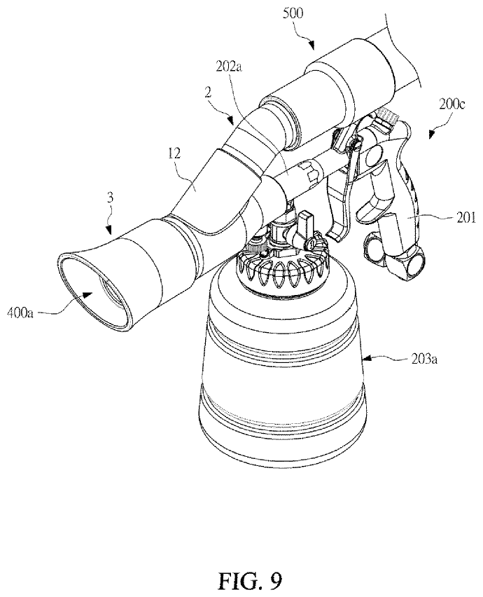

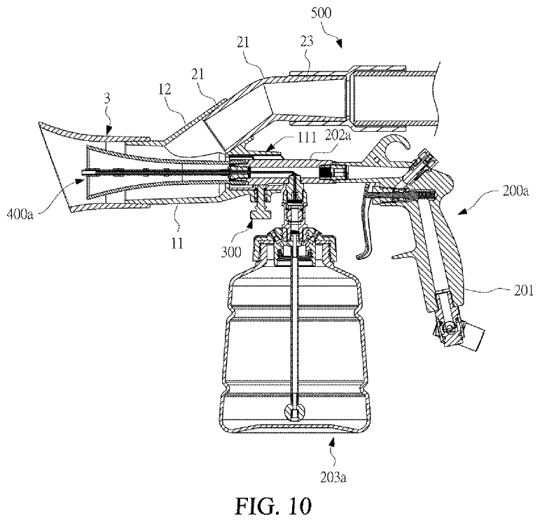

Refer to FIG. 8 to FIG. 10; where FIG. 8 is a schematic view of the first embodiment of the bifurcated dust-collecting adaptor, a gas-fluid spray gun, a gas-operated nozzle and the dust-collecting device in a separate state in accordance with the present invention, FIG. 9 is a schematic perspective view of FIG. 8 in an assembly state, and FIG. 10 is a schematic cross-sectional view of FIG. 9 along line B-B.

As shown in FIG. 1 to FIG. 10, the aforesaid first embodiment of the bifurcated dust-collecting adaptor for spray gun 100 can be assembled to the fluid spray gun 200, and can be also assembled to another fluid spray gun 200a. The fluid spray gun 200a includes the aforesaid spray-gun grip 201, a gun pipe 202a and a fluid-supplying assembly 203a. The first connecting portion 111 is assembled to the gun pipe 202a, and a fluid-guiding pipe 2031a of the fluid-supplying assembly 203a is to penetrate through the gas-operated nozzle 400a. In this embodiment, the spray-gun grip 201 can be also applied to connect a high-pressure air source for providing a high-pressure air, the gun pipe 202a is assembled to the spray-gun grip 201, and the fluid-supplying assembly 203a is assembled to the gun pipe 202a so as to have the fluid-guiding pipe 2031a to protrude into the gas-operated nozzle 400a. Thereupon, when the air provided by the spray-gun grip 201 passes through the gun pipe 202a and the gas-operated nozzle 400a, the fluid inside a fluid container of the fluid-supplying assembly 203a would be drawn into the fluid-guiding pipe 2031a, and then flow along with the high-pressure air flow, according to the Venturi effect.

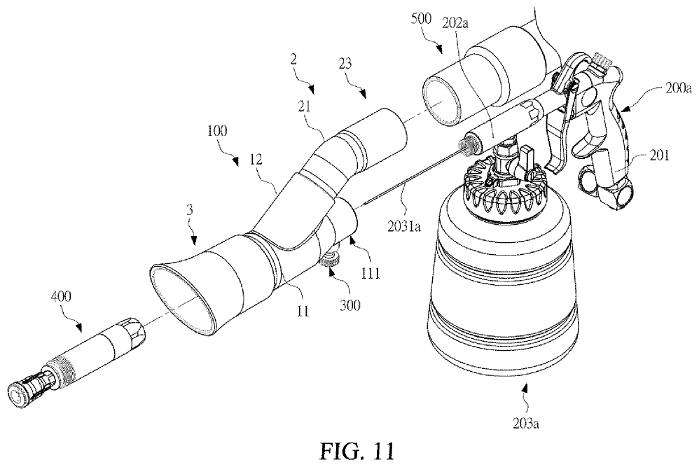

Referring to FIG. 11, a schematic view of the first embodiment of the bifurcated dust-collecting adaptor, a gas-fluid spray gun, a cyclone nozzle and the dust-collecting device in a separate state in accordance with the present invention is shown.

As shown in FIG. 1 to FIG. 11, beside the aforesaid assembling, the first embodiment of the bifurcated dust-collecting adaptor for spray gun 100 can be also assembled to the fluid spray gun 200a and the cyclone nozzle 400.

To sum up, compared with the conventional bifurcated dust-collecting adaptor for spray gun whose spray gun and dust-collecting device can only be integrated at a fixed angle, from which the application of the dust-collecting device to the spray gun is extremely limited, this invention mainly utilizes the first connecting portion of the vacuum adaptor can be rotationally connected with the spray-gun connecting pipe. Thereupon, after the dust-collecting device is assembled to the vacuum adaptor, the vacuum adaptor rotational with respect to the spray-gun connecting pipe can be also rotational to the spray gun connecting the dust-collecting device and the spray-gun connecting pipe, and thus the flexibility and the operability of the spray gun can be effectively improved.

In addition, since the dust-collecting hood is also rotationally assembled to the spray-gun connecting pipe, thus, while the spray gun is utilized to inject a fluid onto a working surface, the angling between the dust-collecting hood and the working surface can be relevantly adjusted per practical, such that both the spray gun and the dust-collecting device can further provide effective cleaning performance to the working surface.

While the present invention has been particularly shown and described with reference to a preferred embodiment, it will be understood by those skilled in the art that various changes in form and detail may be without departing from the spirit and scope of the present invention.

What is claimed is:

1. A bifurcated dust-collecting adaptor for spray gun, assembled to a fluid spray gun and a dust-collecting device, comprising:
a spray-gun connecting pipe, including:
a main pipe body, extending in a first direction thereof from a first connecting portion to a second connecting portion, the first connecting portion being to be assembled to a gun pipe of the fluid spray gun, the second connecting portion being connected spatially with the first connecting portion; and
an oblique extension pipe, protruding from the main pipe body in a second direction oblique to the first direction;
a vacuum adaptor, including:
an adaptor body;
a first connecting portion, protruding from the adaptor body in a third direction reverse to the second direction, configured to be rotationally assembled to the oblique extension pipe; and
a second connecting portion, protruding from the adaptor body in a fourth direction oblique to the third direction, configured to be assembled to the dust-collecting device; and
a dust-collecting hood, rotationally assembled to the second connecting portion.

2. The bifurcated dust-collecting adaptor for spray gun of claim 1, wherein the second connecting portion has a first outer pipe wall, and the dust-collecting hood has a first inner pipe wall to match the first outer pipe wall.

3. The bifurcated dust-collecting adaptor for spray gun of claim 2, wherein the first outer pipe wall and the first inner pipe wall are individually tapered in the first direction.

4. The bifurcated dust-collecting adaptor for spray gun of claim 2, wherein the dust-collecting hood further includes:
a hood pipe, extending in the first direction, having the first inner pipe wall; and
a horn-shape hood, connected spatially with the hood pipe, expanded gradually in the first direction.

5. The bifurcated dust-collecting adaptor for spray gun of claim 1, wherein the oblique extension pipe has a second inner pipe wall, and the first connecting portion has a second outer pipe wall to match the second inner pipe wall.

6. The bifurcated dust-collecting adaptor for spray gun of claim 5, wherein the second inner pipe wall and the second outer pipe wall are individually tapered in the third direction.

7. The bifurcated dust-collecting adaptor for spray gun of claim 1, wherein the main pipe body has an in-pipe space for allowing the gun pipe to penetrate therethrough, and the first connecting portion has a locking hole connected spatially with the in-pipe space, such that, when the gun pipe penetrates through the in-pipe space, a fastener locks the gun pipe in the in-pipe space via the locking hole.
